(19) United States
(12) Patent Application Publication
(10) Pub. No.: US 2008/0183493 A1
(43) Pub. Date: Jul. 31, 2008

(54) Patient Handling Device Specification System and Method of Using the Same

(76) Inventor: Betty Z. Bogue, Hickory, NC (US)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 11/669,228

(22) Filed: Jan. 31, 2007

(51) Int. Cl. G06Q 50/00

(52) U.S. Cl. 705/2

(57) ABSTRACT

A computer program product for specifying the patient handling equipment necessary to physically move a patient in a healthcare facility includes a computer program with a computer readable storage medium having specification commands stored thereon. A patient profile entry device is connected to the storage medium for entering data regarding the patient into the storage medium. The computer readable storage medium commands are executable by a processor to generate an output for showing the equipment that should be used in physically moving the patient. The method of specifying patient handling equipment utilizes the patient's weight and level of independent mobility skills to specify the kind of patient handling device necessary to move the patient. The system includes equipment specification, user training, data tracking, and output modules Patient commands within the equipment specification module evaluate input patient data and assess the patient safety protocol required to move the patient.

### BACKGROUND

The present invention relates to patient handling equipment specification in a healthcare facility to provide healthier environments for patients that need the equipment and healthcare workers that use the equipment. The invention is particularly useful in specifying the equipment, protocol and tracking procedures necessary for moving patients from one location to another; i.e. from bed to chair; in hospitals, nursing homes, and other facilities that provide health related services.

Healthcare workers, 80 percent of whom are women, lead the nation in work-related musculoskeletal disorders (MSDs). The Bureau of Labor Statistics has identified the “healthcare patient” as a leading cause of MSDs. Reducing MSDs in the healthcare workplace requires substituting the manual patient handling tasks with safe and effective alternatives that are integrated and reinforced into the healthcare delivery practice. A successful outcome is the dramatic reduction of MSD incidents.

In addition to providing safer workplaces for healthcare workers, proper patient handling equipment is naturally a must for moving or transferring patients from one location to another. The goal, therefore, is to match the appropriate equipment with each patient's needs, taking into account the amount of mobility that the patient can achieve independently.

Prior efforts in addressing patient mobility in the context of healthcare worker safety include U.S. Pat. No. 7,107,547 (Cule, 2006). The Cule '547 patent, filed on May 30, 2001, discloses a system of graphically indicating patient information on a computer screen and printing that information in hard copy for display in the patient's room. The graphics include a figure that represents the patient, and a number of icons show the patient's health issues.

Of particular interest is Cule's FIG. 3, showing the patient as a teddy bear figure on which icons will be placed. Several of the icons relate to the appropriate method of moving the patient, e.g., “no lift,” “one lift,” “two lift,” “total lift,” and “pivot lift.” The Cule '547 patent fails; however, to disclose a system of assessing the patient for the appropriate patient handling device and specifying the exact model number of the patient handling device. Cule also omits any reference to the data tracking systems that are useful in charting historical injuries to patients and healthcare workers.

U.S. Patent App. Publication No. 2005/0240435 (“the Patalano '435 application”) also addresses certain issues in tracking methods of moving patients. The Patalano '435 patent application discloses a method of producing a medical information report by entering patient data into the computer with certain objective patient care codes. The healthcare facility uses that data to generate queries and reports for analysis.

Patalano's FIG. 3 shows that the appropriate patient transfer mechanism is coded as one of many data regarding each patient. Patalano explains (Paragraph 0198) that the “transfer codes” describe the patient as “independent,” requiring “continual supervision,” “limited assist (1 person),” “extensive assist (1 person),” “extensive assist (2 persons),” “total care (1 person assist),” or “total care (2 person assist).” Patalano, like Cule, gives no indication of the method used to determine the transfer code for each patient. Patalano includes extensive reporting capabilities for patient data in its system.

In a 1999 article published in the International Journal of Industrial Ergonomics (“The Use of Logs to Assess Exposure to Manual Handling of Patients, Illustrated in an Intervention Study in Home Care Nursing), Knibbe discloses the idea of logging lifting activities by nurses in patient care settings. The goal of the study was to register the frequency that nurses use manual lifting techniques and the difference in instances of manual care when a patient handling device is available. Knibbe uses a frequency log to propose back injury prevention policies for nurses. The log was eventually to be used to monitor ergonomic policies in nursing practice on a routine basis.

The Knibbe article is relevant to the idea of tracking caregiver data in addition to patient data regarding injuries incurred during patient transfers. The Knibbe article shows a previous attempt at capturing data to track and improve on such injury rates.

The background literature shows a significant void in the field of patient transfer systems, equipment specification, and injury tracking for both patients and the healthcare workers that move them.

### SUMMARY OF THE INVENTION

In one aspect, the invention is a computer program product for specifying the patient handling equipment necessary to physically move a patient in a healthcare facility. The computer program comprises a computer readable storage medium having specification commands stored thereon. A patient profile entry device is connected to the storage medium for entering data regarding the patient into the storage medium. The computer readable storage medium commands are executable by a processor to generate an output for communicating to the healthcare worker the equipment that should be used in physically moving the patient.

In another aspect, the invention is a method of specifying patient handling equipment for physically moving a patient in a healthcare facility. The method includes the patient's weight, determining the level of the patient's mobility skills, and specifying the type of patient handling device necessary to assist in safely moving the patient.

In yet another aspect, the invention is a computerized system of specifying and tracking the safety protocol for physically moving patients in a healthcare facility. The computerized system includes a computer readable storage medium having an equipment specification module, a training module, a data tracking module, and an output module stored thereon. The specification, training, tracking, and output modules are executable by a processor to interact with a data entry device for inputting data onto the storage medium. Patient commands within the equipment specification module evaluate input patient data and assess the patient safety protocol required to move the patient. Computer-controlling data tracking commands within the data tracking module record events associated with moving patients in the healthcare facility. Computer-controlling training commands within the training module allow for developing the skills of system users. Output commands within the output module generate a system output from the modules.

Overall, the invention is a computerized system of establishing a safety protocol for moving patients in a healthcare facility so that neither the patient nor the healthcare worker is injured.

### BRIEF DESCRIPTION OF THE DRAWINGS

FIG. 1 is a flowchart showing the decision tree for specifying the appropriate equipment in moving a patient in a healthcare facility.

FIG. 2 is front view of a system screen layout according to this invention.

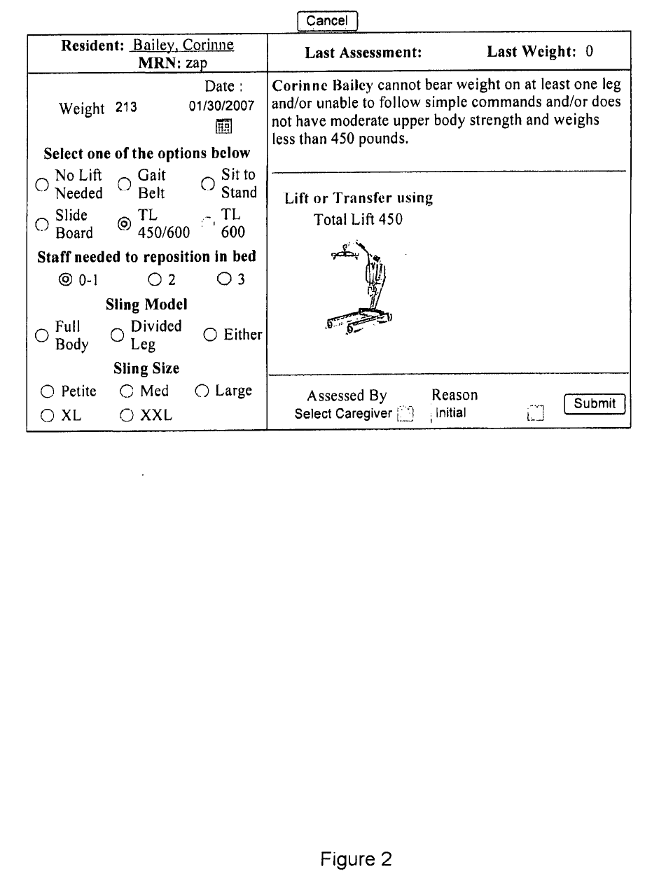

FIG. 3 is a schematic representation of the overall computer system for specifying patient handling device as installed in a healthcare facility.

FIG. 4 is a schematic representation of the consultant management capabilities of an installed system according to this invention.

FIG. 5 is a schematic representation of the computer system network components for specifying patient handling device as installed in a healthcare facility.

FIG. 6 is a flowchart of software for entering the computerized system for specifying patient handling device and performing the required training.

FIG. 7 is a detailed flowchart of software for training healthcare workers on the computerized system of specifying equipment and tracking patient transfer data in a healthcare facility.

FIG. 8 is a flowchart of software that a trainee encounters upon completing the training protocol for the method of specifying patient handling device.

FIG. 9 is a flowchart of software that a trainee encounters upon completing the training protocol for the method of specifying patient handling device.

FIG. 10 is a flowchart of software that a trainee encounters upon completing the training protocol for the method of specifying patient handling device.

FIG. 11 is a flowchart of software that tracks system user training status.

FIG. 12 is a schematic of the training protocol according to this invention.

FIG. 13 is a schematic representation of the patient transfer assessment module according to this invention.

FIG. 14 is a schematic representation of the equipment database and selection program according to this invention.

FIG. 15 is a flowchart of information processing for tracking injuries in a healthcare environment, such injuries being incurred by patients and healthcare workers in transferring patients.

### DETAILED DESCRIPTION

In a first embodiment, the invention is a method of specifying patient handling equipment for physically moving a patient in a healthcare facility. Overall, the method includes entering the patient's weight, determining the level of the patient's independent mobility skills, and specifying the kind of patient handling device necessary to assist in safely moving the patient. In a preferred embodiment, the software is available via internet log-in by nurses and other medical professionals who are responsible for ensuring the safe transfer and re-positioning of patients in hospitals, nursing homes, and other medical facilities. The system includes functionality that tracks significant data for injury reduction, insurance costs, and overall efficiency in managing patients that have less than one hundred percent independent mobility.

Certain terms used in this invention are terms of art used in the field of patient transfer within healthcare facilities. Although the invention is not limited to equipment described herein, several patient handling devices are described for clarity. Terms of particular importance include “gait transfer belt,” “slide board,” “slide sheet”, “sit-to-stand lift,” and “total lift.” A “gait transfer belt” is a standard piece of equipment worn as a belt by a patient with sufficiently high independent mobility skills. The healthcare worker keeps the patient steady by holding the belt to add to the patient's stability while walking. A “slide board” is a patient handling device that operates just as the name implies. They are used to slide patients between wheelchair and car, bed or easy chair, without the need to lift, hence reducing the risks of strains to caregivers. The slide board provides a flat surface from one location to the next, across which the patient slides to move into a new spot. A “patient handling mechanical lift” is also somewhat self-explanatory and commonly used. Patient handling lifts include straps, slings, or even hammock type attachments to a mechanical device, typically motorized, that lifts the patient partially or totally, depending upon the patient's independent mobility. For example, a “sit to stand” lift is a rolling, portable apparatus with a large base and handles that a caregiver uses to move a patient from a seated to standing position. The sit to stand lift includes belts or straps that give the patient that extra support needed to safely transfer for example, from bed to chair. A “total lift” has a sufficiently large sling or hammock type attachment that the patient's entire body is supported by the lift device and moved with little to no effort by the patient. In the context of this invention, a “sling” attaches to a total lift and holds a considerable amount of the patient's weight, i.e., a sling for this patient handling device is the same concept as a sling for a single body part in terms of support, but the term sling as used herein entails significantly more support to the patient. Slings generally come in full body slings in which the patient sits and divided leg slings which is placed under each of the patient's legs and then attached to the lift. These patient handling devices are discussed herein as examples of equipment with which the patient transfer system can be used.

One significant component of the invention is the patient assessment protocol that determines the kind of equipment to use in handling that patient. The patient assessment gathers information regarding the patient's ambulatory skills, patient's weight, standing capability, upper body strength, and overall cognitive capacity to determine the level and kind of assistance required in moving the patient to a different location or re-positioning that patient in bed. These are key factors in specifying the number of healthcare professionals that the patient requires and/or the best equipment to use for ultimate safety. By using objective standards to evaluate these factors, the medical personnel can identify each piece of equipment that should be gathered prior to moving the patient and contact the appropriate number of co-workers to help.

After assessing the patient, the medical personnel code the information onto charts for the patient's room. The charts, e.g. stickers, can be located on the door to the patient's room, by the patient's bed, or any other location that alerts the medical staff to that patient's needs. The invention tracks the coding that should be used on these identifying charts for each individual patient.

The invention has multiple levels of data gathering, tracking, and reporting capabilities. The software allows the healthcare facility to monitor in real time the dates of patient assessments, due dates for future assessments, caregiver incidents and accidents, caregiver training records, and equipment maintenance records. The software is sufficiently flexible for the user to have customized reports for other data as well. One useful data tracking component, for example, shows trends in patients' weight for diagnostic purposes. All of the reports are available with user friendly graphics and charts for the facility to more easily recognize data patterns.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In one aspect, the invention is a computer program product for specifying the patient handling equipment necessary to physically move a patient in a healthcare facility including a computer readable storage medium containing equipment specification commands, a patient profile entry device, and an output. In this embodiment, the user of the invention enters data regarding the patient into the storage medium using the entry device. Typically, this could be accomplished with a keyboard that interacts with a specially designed data entry screen. The equipment specification commands then generate the output based on the data entered, thus identifying the correct equipment to use based on the specific attributes of the patient in question. The output may also be generated on a sticker for display near the patient's bed to provide easy reference.

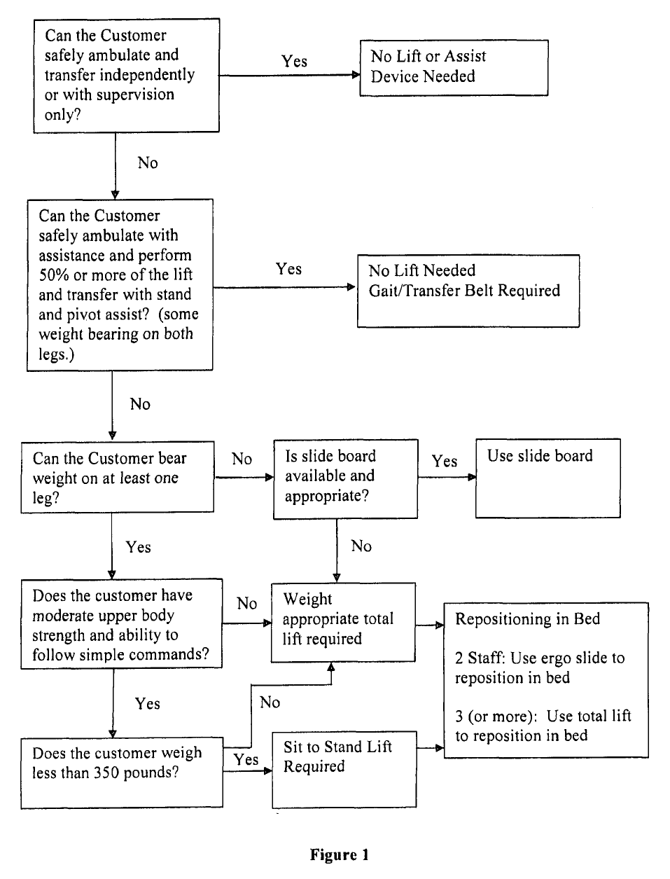

An example of this arrangement is a software program, shown as a flowchart in FIG. 1, accessible by computer. In a most preferred embodiment, the computer program is accessible via any internet-connected computer or other computerized system. The nurse or other medical professional seeking to choose the proper equipment logs in to the software and enters the patient's information. The program then processes this information and identifies the equipment best suited for the use. As a result, the medical professional is prevented from using equipment that is not intended for the desired use, which could lead to injury to the patient or the medical professional.

The information that makes up the patient profile may include a variety of attributes, including the patient's weight, the kind of equipment needed for the task, the number of people needed to assist a patient, or determinations of the patient's mobility and strength. Based on this information input into the program, the program will be able to select equipment that will be ideally suited for the specific needs of the patient.

For example, if the patient's weight is entered, the program can identify patient handling equipment that can support the patient's weight. The processor for specifying equipment is electronically linked to a database of equipment available at the location. The equipment specification commands generate a list of available equipment that can be used in moving a patient of the given weight. The healthcare professional then selects from the list of available equipment by answering an equipment selection prompt.

Using equipment that is capable of fully supporting the patient thus relieves the medical professional from having to support some of the weight not carried by the equipment, which could lead to injury. To clarify the type of equipment that should be selected from an available equipment list, the patient profile entry device may include instructions that describe the type of equipment available and the best uses of each.

The user may enter the kind of patient handling device to be used in moving the patient to provide limitations on the suggestions made by the program. For example, if the patient can safely move and transfer independently, no patient handling device would be needed. Alternatively, if the patient experiences some difficulty in lifting or transferring himself or herself, but can bear weight on at least one leg, has moderate upper body strength, and can follow simple commands, a weight appropriate total lift would be recommended.

For users that may not be familiar with the different situations in which certain kinds of equipment are needed, the program may provide selection instructions for helping the user determine which equipment should be used in moving the patient. These selection instructions may be in the form of a decision tree that requires the user to evaluate a series of yes or no questions regarding the patient's physical condition. In another embodiment, the program may do more than provide instruction but actually prompt the user for mobility data representing an assessment of the patient's ability to stand and ambulate with no physical assistance from the caregiver. In a preferred embodiment, the “mobility data value” is expressed as a percentage of a complete patient transfer that the patient can accomplish independently. This percentage is determined by the qualified healthcare professional making an assessment according to standards in the industry and the experience of that healthcare worker. The mobility data value for a particular patient may be defined by the patient's ability to sit on the side of a bed independently and kick his or her lower leg out with moderate resistance applied. Trained professionals then quantify the patient's performance of these types of tasks to determine the mobility data value. The program then compares the mobility data value with a mobility threshold value to determine what kind of patient handling device is needed. The threshold value is determined by historical data analysis showing that certain types of equipment work best when a patient has a particular level of mobility. In the example of FIG. 1, the mobility data value is set at 50% to begin determining the appropriate equipment specification for transferring that patient.

Trained healthcare workers use training, institutional knowledge, and historical data regarding patients and equipment to assess a number of physical parameters. These physical parameters are used to specify the appropriate piece of equipment to move a patient. Similar to assessing a patient's mobility data value, the heath care worker can assess the patient for a leg strength data value, a leg strength threshold for each piece of equipment, a slide board suitability value, an upper body strength data value, a cognitive ability data value, and respective thresholds for the upper body strength and cognitive ability.

The above noted data values and threshold values are determined only by trained professionals that are extraordinarily familiar with moving patients and with the associated equipment. In the preferred embodiment of a computerized system for specifying patient handling device, the various physical parameter data values and the associated threshold values are constants programmed into the system upon installation at that location.

For example, if the patient can move without assistance, no patient handling device may be necessary. If the patient is considered to have a mobility of greater than 50%, but some assistance is still required, a simple patient handling device such as a gait belt may be all that is needed. If the patient has a low mobility rating, i.e., below 30%, a patient handling device providing a greater level of assistance may be needed.

The determination of what equipment is needed for these low-mobility patients may be further developed. For patients exhibiting low mobility, the program may further prompt the user for determinations of the patient's leg strength, upper body strength, and ability to understand and follow instructions, i.e., the data values. For example, if the patient's leg strength is below a defined threshold, the program may further ask the user whether a patient handling device such as a slide board is available and appropriate for the task. A slide board may be needed in cases such as where the patient lacks adequate sitting balance to sit on the side of the bed independently or lacks the arm strength to move his or her torso laterally. If a slide board is not appropriate but the patient's upper body strength and cognitive ability are both sufficient, the program may recommend patient handling device, such as a sit to stand lift, if the patient's weight is less than the weight limits per the lift vendor's specifications; or a total lift if patient's weight excess the limits of the sit to stand lift. If, however, either the patient's upper body strength or cognitive ability is insufficient, a total lift will be assigned. Based on these inputs, the program is thus able to determine what specific equipment may be best suited for the patient's needs.

If support equipment is needed, the user may further input the type of sling to be used in moving the patient, which may be based on the patient's body type and support needs. For example, a sling that would be appropriate for the average patient may not be appropriate if the patient is a double amputee or single amputee above the knee.

The user may be able to input the number of people who are generally needed to reposition the patient in bed. The program may use this information to identify equipment that may assist the caregivers in performing the task. For example, if fewer than two people are needed to assist the patient, no patient handling device may be necessary. If two people are needed, a patient handling device such as a slide sheet may be of some help. If it takes three or more people to reposition the patient, a total lift may be recommended.

In another embodiment, the invention is a method of using patient handling equipment for physically moving a patient in a healthcare facility. The method may include the steps of determining the patient's weight and level of independent mobility skills, entering these values into a computer processor, which assigns the kind of patient handling device needed to assist the caregiver in safely moving the patient, and then using the recommended equipment. A sticker may be generated for display near the patient's bed to assist the caregiver in identifying the appropriate equipment to use in lifting or moving the patient.

There are a number of ways in which a patient's independent mobility skills may be measured. In one embodiment, the patient's mobility skills may be quantified by determining whether moving the patient requires a second person to lift more than about 31 pounds of the patient's weight. For the most experienced healthcare workers, the position of the caregiver's lifting arm during a successful lift is a good indication of whether the caregiver is lifting more than 31 pounds during the move. The figure of 31 pounds has been determined as the maximum amount that any caregiver should repetitively move to avoid long term injury. In an alternate embodiment, the patient's mobility skills may be measured as the percentage of a complete patient transfer that the patient can accomplish independently.

Once the patient's independent mobility skills are quantified, that measurement may then be compared to a mobility threshold value to determine whether or not a patient handling device is necessary for that patient. The measurement may further be used to identify the proper kind of patient handling device necessary to assist in safely moving the patient. For example, if the mobility data value is greater than or equal to 50 percent, a gait-transfer belt may be assigned to the patient. In a further use of the method of this invention, if the mobility data value is less than 50 percent, further analysis is necessary to identify the proper equipment other than a gait transfer belt.

For such patients exhibiting low mobility measurements, a leg strength data value representing the patient's ability to bear weight on at least one of the patient's legs is measured. If the leg strength data value is below a leg strength threshold, the step of specifying the kind of patient handling device may further involve assigning the patient a slide board suitability value representing whether a slide board is appropriate to move the patient. If a slide board is considered appropriate and available, the appropriate slide board is assigned for moving the patient. If a slide board is not appropriate, the appropriate patient handling equipment must be determined.

To determine the appropriate patient handling equipment to be used, measurements of the patient's upper body strength and cognitive ability may be made. If either of the upper body strength data value or cognitive ability data value is below its respective threshold, then a total lift capable of supporting the patient's weight should be used. Alternatively, if the upper body strength data value and cognitive ability data value are both above their respective thresholds, the step of specifying the kind of patient handling device involves matching the appropriate patient handling device to the patient's weight. A sit to stand lift may be used, if the patient's weight does not excess the limit per the lift vendor's specifications. If the patient's weight excess those limits, then a total lift is required.

The appropriate equipment for repositioning the patient in bed may also be identified by determining the number of caregivers required to reposition the patient in bed and then assigning the appropriate equipment based on that number.

Again, once the proper equipment for moving the patient is specified, a sticker for display near the patient's bed may be generated to clearly identify the equipment that should be used to move or reposition the patient.

In yet another aspect, the invention is a computerized system of specifying and tracking the safety protocol for physically moving patients in a healthcare facility. The invention includes a computer readable storage medium having an equipment specification module, a training module, a data tracking module, and an output module stored thereon, all modules executable by a processor.

The equipment specification module includes computer-controlling patient commands for evaluating input patient data and assessing the patient safety protocol required to move the patient. This module may comprise a computer readable storage medium containing equipment specification commands executable by a processor to direct the output module to show the image of the equipment that should be used in physically moving the patient.

The data tracking module includes computer-controlling data tracking commands for recording events associated with moving patients in the healthcare facility. This module may include a computer record for each system user or a record for each patient requiring a patient assessment. Relevant patient data used by this module may include patient biographical data, prior patient assessment dates, scheduled patient assessment dates, patient assessment results, patient weight, patient care instructions, patient location, and changes in patient location. This module may also include an equipment tracking database for tracking each kind of equipment available for moving patients in the system user's facility, including details on the equipment such as images, warranty data, parts data, service data, and maintenance history data.

The training module includes computer-controlling training commands for training system users in a method of moving patients in the healthcare facility. The training module may include video content directed to assessing a patient's safety protocol or a competency examination for system users. The training module may further communicate with the data tracking module to record the results of each user's competency examination.

The output module includes computer-controlling output commands that generate a system output from the modules. The system output may include a safety protocol for moving a patient, a caregiver data summary, a patient data summary, an injury summary, and any combination thereof. The output may further show the equipment to be used in moving the patient, such as of a gait belt, a slide board, a total lift, or a sit to stand lift.

A data entry device is provided for inputting data onto the storage medium for use by the modules. The data input may include the patient's weight, the kind of patient handling device to be used in moving the patient, the number of people needed to reposition the patient in bed, and/or the kind of sling for moving the patient.

This embodiment of the invention may be configured in an internet-accessible server and client relationship. In this setup, the data tracking module would be a database. The server may host a public website for gaining access to the system. Users who access the website may then access a client sub-domain for the specific healthcare facility using the system. The public website would then communicate with a second server dedicated to the client.

In yet another embodiment, the invention is a computerized system of establishing a safety protocol for moving patients in a healthcare facility. In this embodiment, the invention includes a computer readable storage medium having equipment specification commands executable by a processor to assess the kind of equipment that should be used to move a patient. The storage medium includes an injury tracking module accessible by the system user to calculate trends in patient-moving safety, a data entry device for entering data regarding patients and injuries into the storage medium for use by the equipment specification commands and said injury tracking module, and an output module for showing the equipment that should be used in physically moving the patient and for showing the calculated safety trends.

The data entry device may include a client dashboard for the user to input injury claim data into said storage medium. The injury tracking module may then include a computer record of each patient-moving injury occurring in the user's healthcare facility or a loss run application for confirming that an input injury claim is related to a patient move or transfer. Such a loss run application may include a means for editing the claim detail entered through the client dashboard.

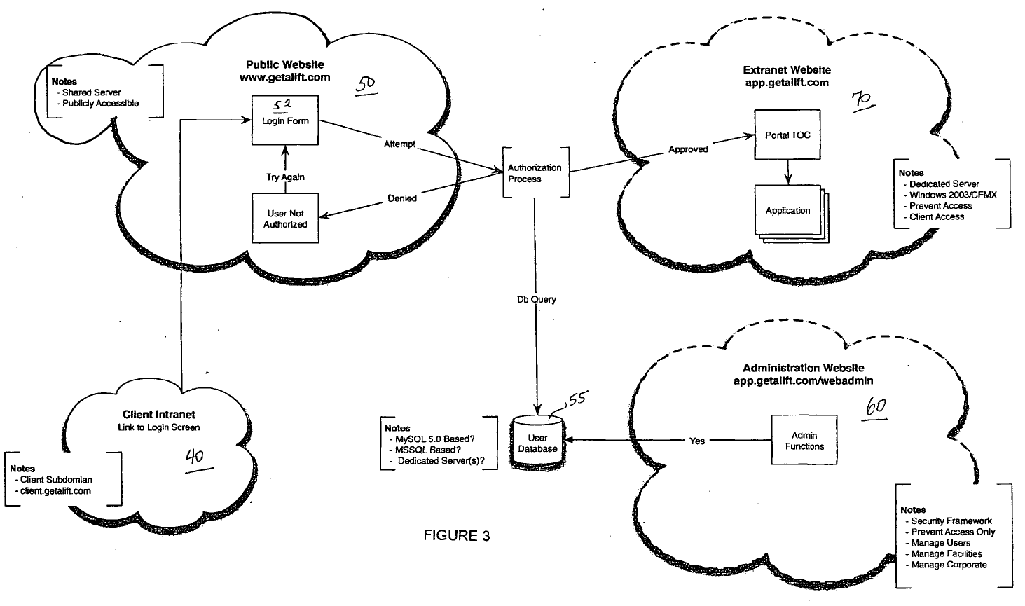

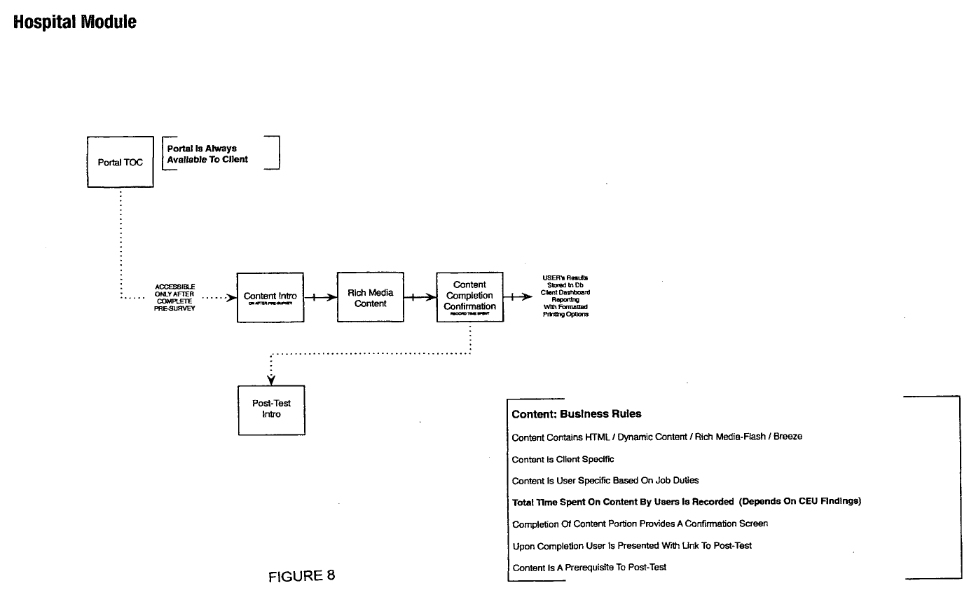

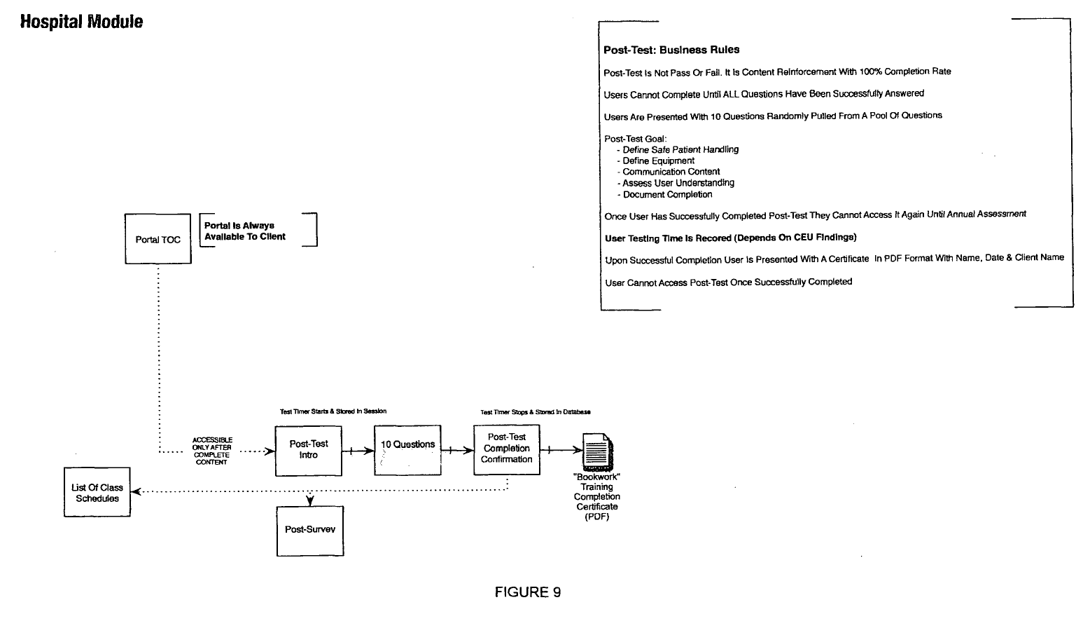

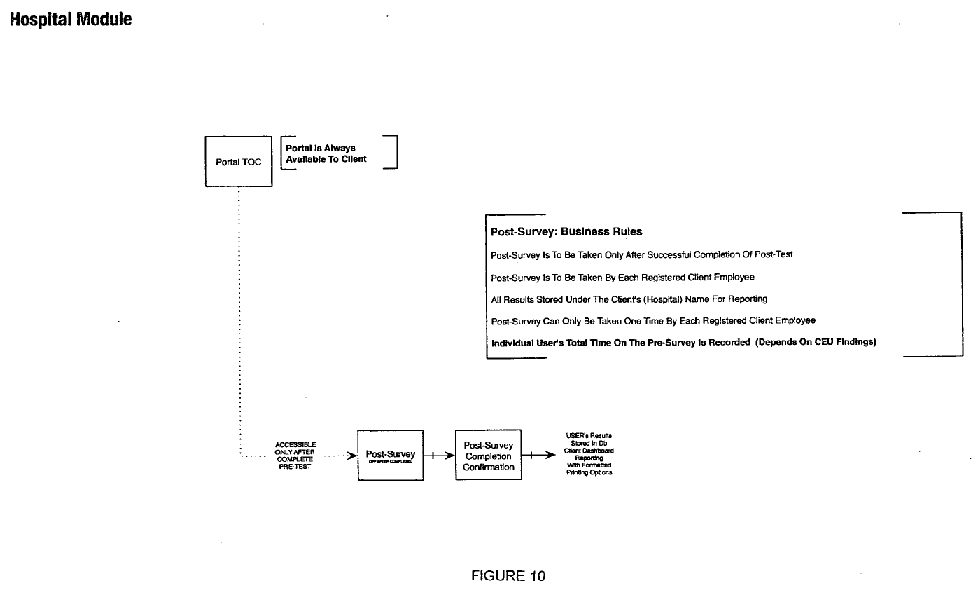

FIGS. 3-15 show one preferred embodiment for implementing the computerized system of establishing a safety protocol for moving patients in a healthcare facility. As shown in FIG. 3, a healthcare worker logs into the network (40) from a public web site (50). The system has a log in protocol (52) to ensure that only authorized users access to data therein. Standard security techniques are available to maintain a user database for authorization purposes. Only authorized administrative professionals (60) will have access to update the user database (55) and allow trained healthcare workers to use the system. The authorization process utilizes a security protocol located at the healthcare facility's site. The security protocol, however, can access an application portal (70) maintained by the administrator of the system off-site.

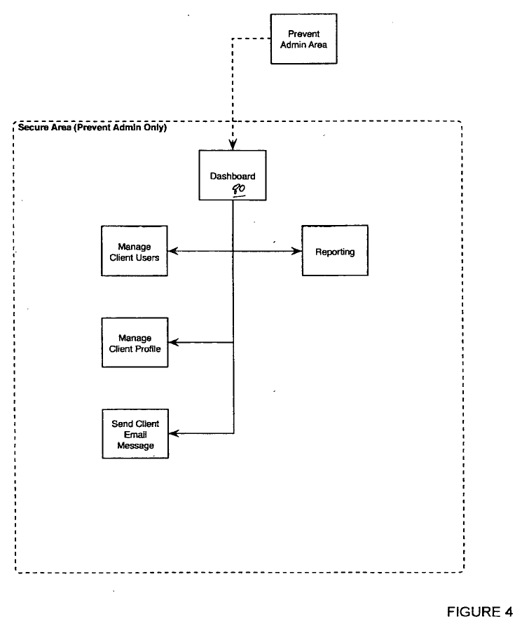

FIG. 4 outlines the types of screens that the off-site administrator would encounter when working with an installation at a healthcare facility. In general, the administrator utilizes a dashboard (80) that allows access to numerous management functions within the system. In this way, the off site administrator can oversee the installation of the system in a client's healthcare facility. Among the functions accessible through the dashboard (80) are client user management tools, client profiles, reporting capabilities, and telecommunication issues. By using this tool, the off-site administrator can help facility directors and individual program administrators run the overall network.

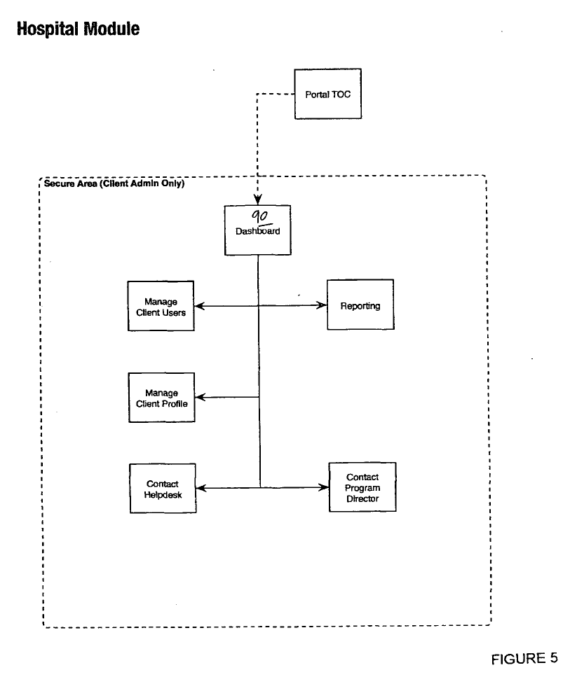

The client installing and utilizing the equipment specification system in its healthcare facility has corresponding management tools at its facility that are locally available. As shown in FIG. 5, the client also utilizes a dashboard (90) to manage the users, certain client profile information, help desk systems, and reporting functions.

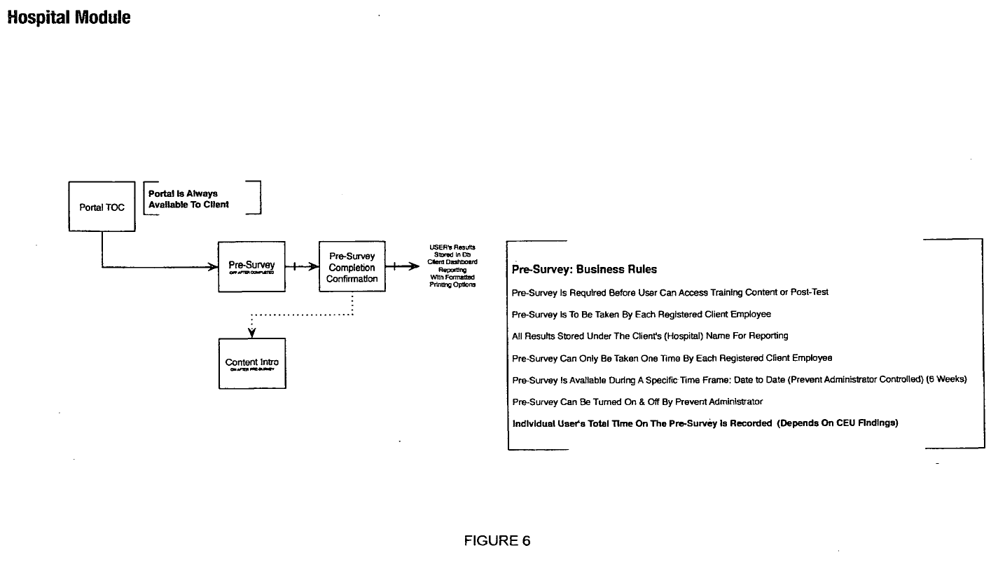

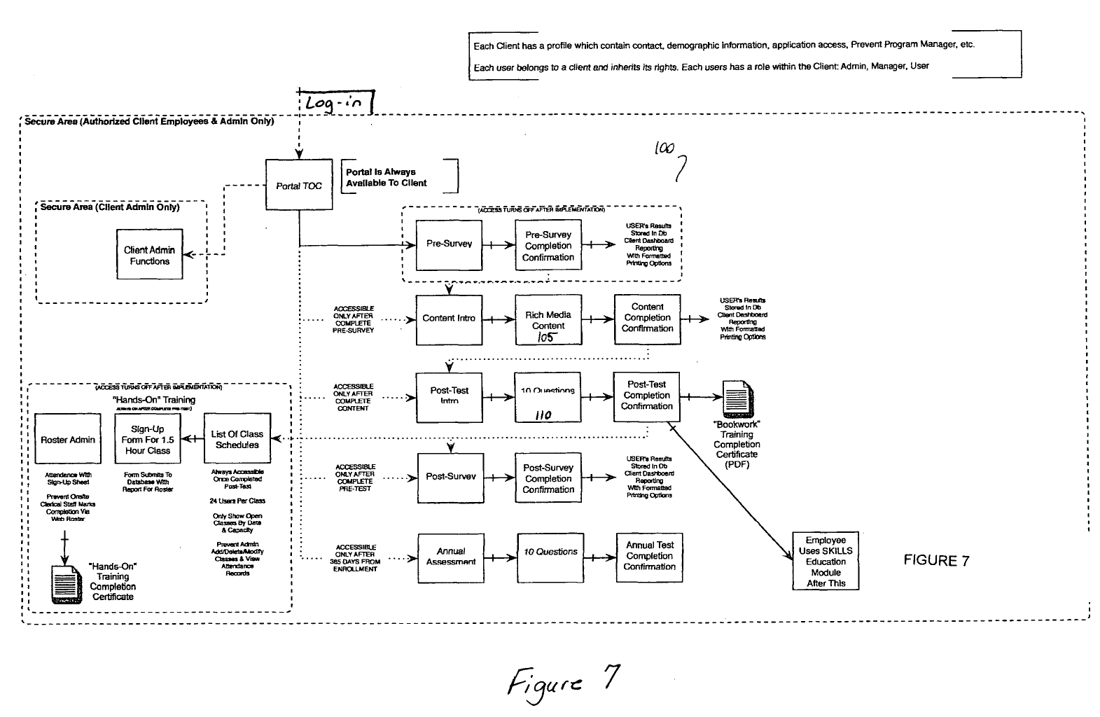

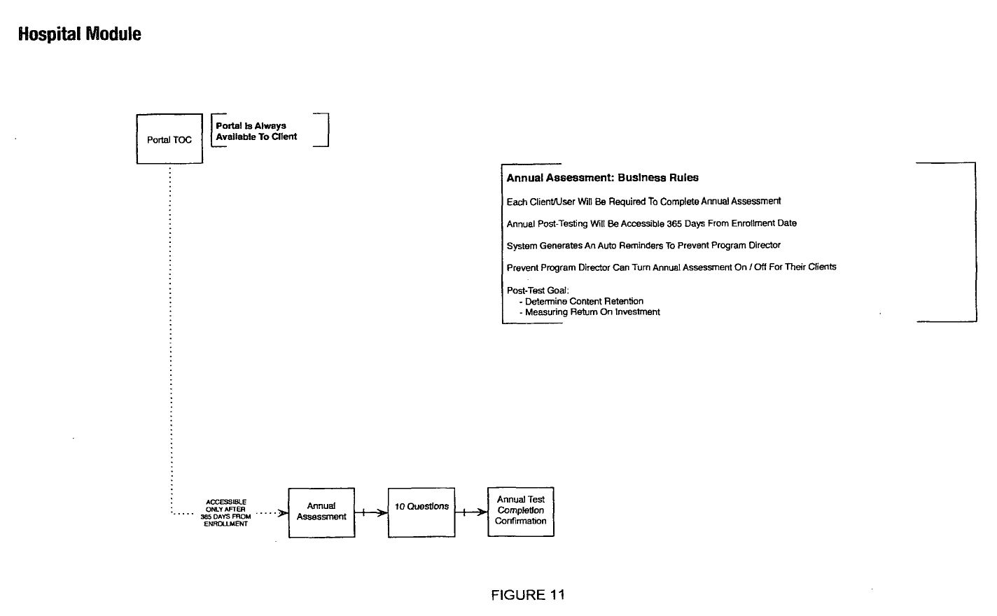

As shown in FIG. 6, one of the main management functions is that of training. In a preferred embodiment of this invention, the training protocol is individualized for each healthcare worker that must specify and/or use equipment to move individual patients. The system tracks the caregivers' completion of required training and dates of scheduled further training. Before a user is allowed to use the system for training, however, the user must answer certain questions in a pre-survey for record keeping. FIGS. 7-10 provide more detailed information regarding the training protocol used in implementing the system for specifying patient handling device. In general, the training protocol (100) includes an interactive rich media content (105) in which the user answers questions (110) related to assessing patients and determining the appropriate equipment for moving the patient. The training module (100) also includes annual follow up training, as shown in FIG. 11, for caregivers that pass the initial training.

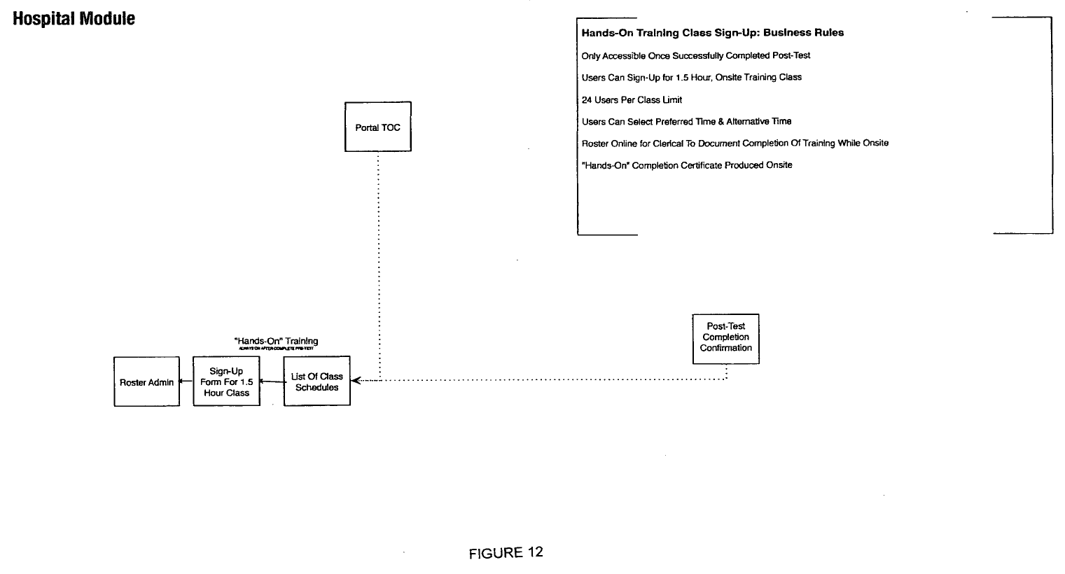

After passing the substantive content tests necessary to be proficient with the system, the invention contemplates scheduling hands on training with the computerized version of the equipment specification program in the actual equipment that the caregiver must use. As shown in FIG. 12, the system according to this invention is fully capable of tracking each caregiver's completion of training and hands on experience to ensure that only properly trained qualified caregivers move patients in a healthcare environment.

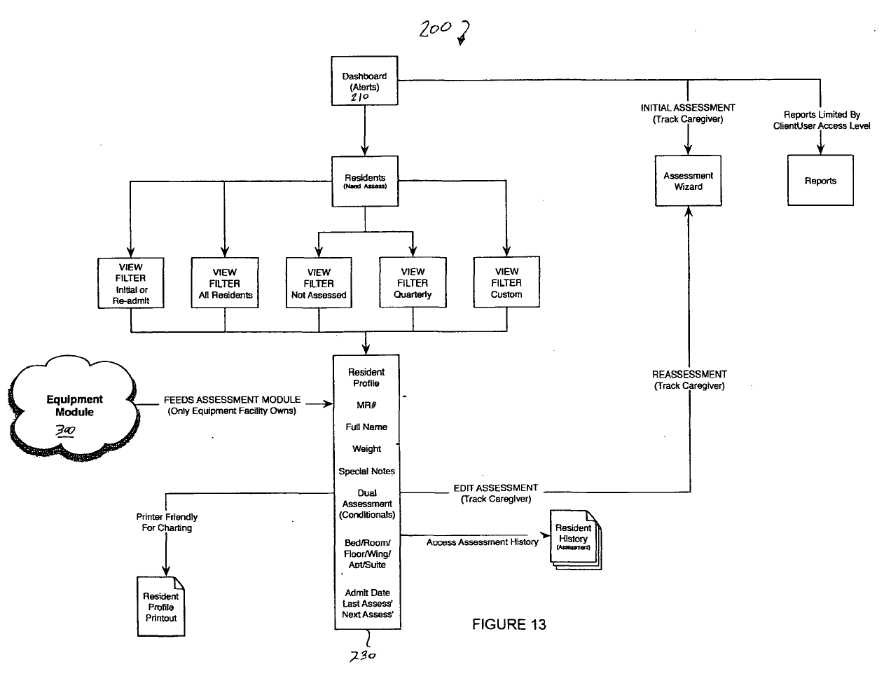

FIG. 13 shows more detailed application requirements for the assessment module described above. According to this invention, the assessment module (200) includes an introductory dashboard (210) through which the caregiver can access data regarding the residents of a healthcare facility. As noted above, an equipment specification system according to this invention tracks significant data regarding each patient residing in the facility. As shown in block (230), the system assessment module (200) tracks data such as the name, weight, assessment conditions, and location of the patient. All this information is available for charting in the patient file and for printing to be displayed in the patients room as necessary. The assessment module (200) communicates with the equipment module (300) to ensure that the appropriate piece of equipment is the available for use upon specification.

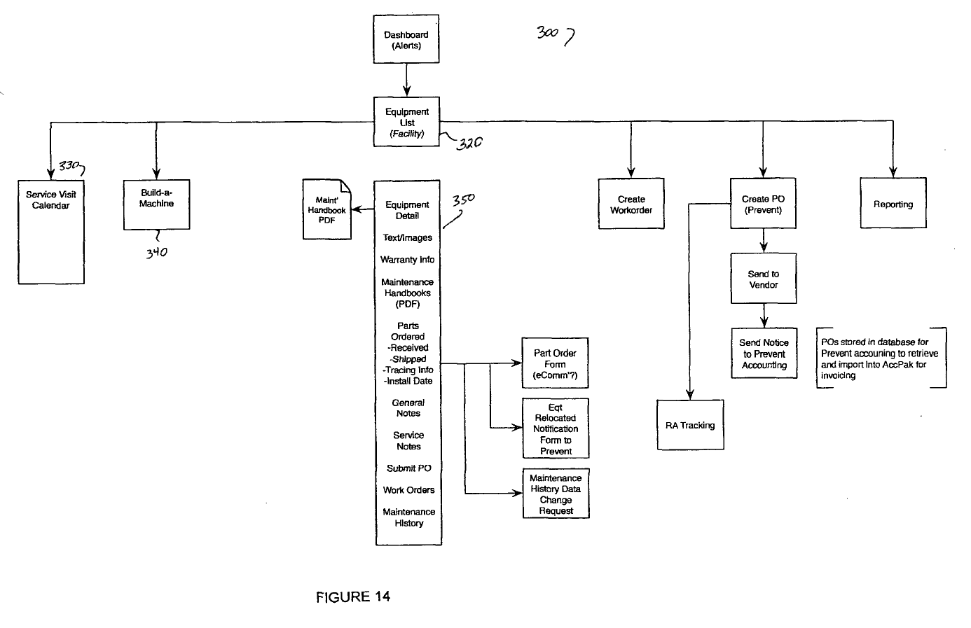

The equipment module (300) includes a database of equipment that is available at the facility. In this way the caregiver will select only equipment that is actually nearby for use. As shown in FIG. 14, the equipment list (320) tracks information about each piece of equipment including service calls (330), equipment configuration (340), and individual data about specific pieces of equipment as shown in block (350). The individualized equipment data (350) includes images of the equipment along with a text description of the same. The system also tracks warranty information, maintenance reports, and historical accounting data regarding each machine. In one embodiment of the invention, the equipment module links to various accounting programs for purchasing equipment and requesting upgrades.

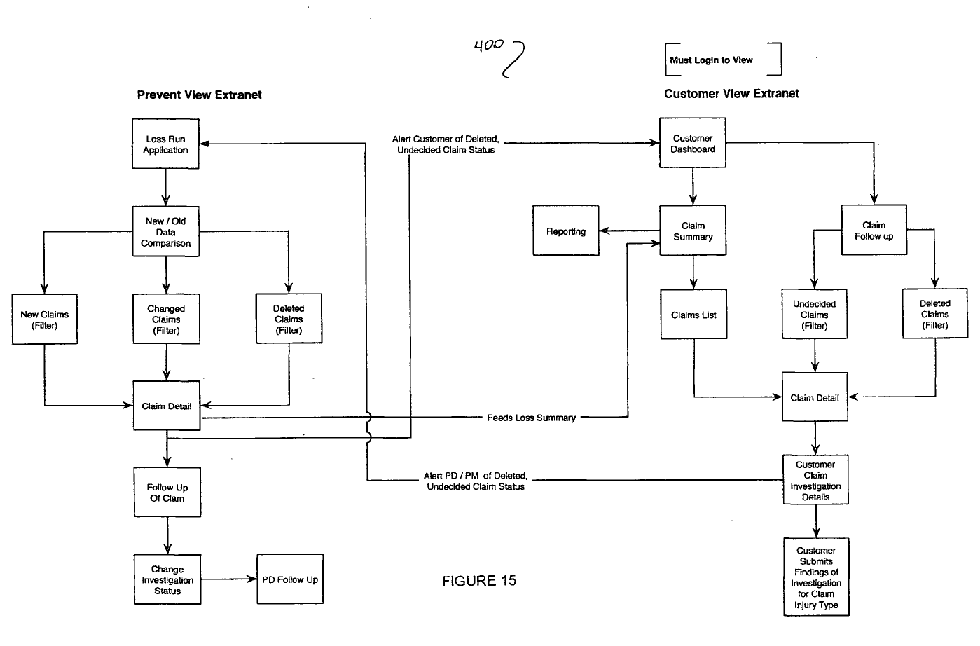

FIG. 15 is a block diagram showing the decisions made in reporting injuries properly for system recording and for insurance purposes. As noted above the invention can be described as a computerized system of establishing a safety protocol for moving patients in a healthcare facility. The system also provides an injury tracking module (400) stored on the system storage medium, the module is accessible as shown in FIG. 15, the system administrator must ensure that the injury data accurately reflects each injury incurred in transferring patients from one location to another. The injuries tracked in the system include injuries to the caregivers as well as injuries to the system provides an automated method of separating non transfer injuries from patient transfer injuries. For example, for the tracking system to be valid, injuries related to the patient's other medical conditions or the caregiver's duties besides moving patients must be removed from the data. The system herein is a patient transfer device and tracks injuries related to such.

In the specification and the figures, typical embodiments of the invention have been disclosed. Specific terms have been used only in a generic and descriptive sense, and not for purposes of limitation. The scope of the invention is set forth in the following claims.

1. A computer program product for specifying the patient handling equipment necessary to physically move a patient in a healthcare facility, comprising:
a computer readable storage medium comprising equipment specification commands stored thereon, said commands executable by a processor;
a patient profile entry device for entering data regarding the patient into said storage medium for use by said equipment specification commands; and
an output generated by the equipment specification commands for showing the equipment that should be used in physically moving the patient.

2. A computer program product according to claim 1, wherein said patient profile entry device comprises a weight prompt for entering the patient's weight.

3. A computer program product according to claim 2, wherein said equipment specification commands generate a selection of equipment based upon the patient's weight.

4. A computer program product according to claim 3, wherein said patient profile entry device comprises an equipment selection prompt for entering the kind of patient handling device to be used in moving the patient.

5. A computer program product according to claim 3, wherein said patient profile entry device comprises equipment selection instructions for determining which equipment should be used in moving the patient.

6. A computer program product according to claim 3, wherein said patient profile entry device comprises a reposition prompt for entering the number of people needed to reposition the patient in bed.

7. A computer program product according to claim 3, wherein said patient profile entry device comprises a sling prompt for entering the kind of sling to be used in moving the patient.

8. A computer program product according to claim 1, wherein said patient profile entry device prompts a caregiver to enter a mobility data value representing the percentage of a complete patient transfer that the patient can accomplish independently.

9. A computer program product according to claim 8, wherein said equipment specification commands compare said mobility data value with a mobility threshold value to determine if no patient handling device is necessary for that patient.

10. A computer program product according to claim 8, wherein said output shows that a gait-transfer belt is a functional option when said mobility data value is greater than or equal to 50 percent.

11. A computer program product according to claim 8, wherein said patient profile entry device prompts a caregiver to provide a leg strength data value if said mobility data value is less than 50 percent, said leg strength data value representing the patient's ability to bear weight on at least one of the patient's legs.

12. A computer program product according to claim 11, wherein said equipment specification commands compare said leg strength data value with a leg strength threshold value, and if said leg strength data value is below the leg strength threshold, said patient profile entry device prompts the user for a slide board suitability value representing the decision of whether a slide board is appropriate to move the patient.

13. A computer program product according to claim 12, wherein if said slideboard suitability value represents an affirmative suitability, then said output shows the appropriate slide board for moving the patient.

14. A computer program product according to claim 12, wherein if said slideboard suitability value represents a negative suitability, then said output shows the appropriate total lift equipment as calculated by said equipment specification commands.

15. A computer program product according to claim 11, wherein if said leg strength data value is more than the leg strength threshold, then said patient data entry device prompts the caregiver to enter an upper body strength data value and a cognitive ability data value for comparison to respective upper body and cognitive threshold values.

16. A computer program product according to claim 15, wherein if either said upper body strength data value or said cognitive ability data value is below its respective threshold, then said output shows the appropriate total lift as calculated by said equipment specification commands.

17. A computer program product according to claim 15, wherein if said upper body strength data value and said cognitive ability data value are both above their respective thresholds, then said equipment specification commands assign an appropriate patient handling device based on the patient's weight.

18. A computer program product according to claim 17, wherein said equipment specification commands assign a sit to stand lift if the patient's weight is less than the weight limit per the lift vendor's specifications.

19. A computer program product according to claim 17, wherein said equipment specification commands assign a total lift if the patient's weight is greater than the weight limit per the lift vendor's specifications for a sit to stand lift.

20. A computer program product according to claim 17, wherein said patient data entry device prompts the user to enter the number of caregivers required to reposition the patient in bed.

21. A computer program product according to claim 20, wherein said equipment specification commands calculate the appropriate equipment for repositioning the patient depending on the number of caregivers required.

22. A computer program product according to claim 1, wherein said output is generated on a sticker for display near the patient's bed.

23. A computer program product according to claim 1, wherein the computer program product is an equipment specification module within a computerized system.

24. A computer implemented method of specifying patient handling equipment for physically moving a patient in a healthcare facility, comprising:
determining the patient's weight;
determining the level of the patient's independent mobility skills;
inputting the weight and the level of skills into a computer processor;
specifying the kind of patient handling device necessary to assist in safely moving the patient by executing computer controlling commands stored on the processor.

25. A computer implemented method according to claim 24, wherein the step of determining the patient's independent mobility skills comprises determining whether moving the patient requires a second person to lift more than 31 pounds of weight.

26. A computer implemented method according to claim 24, wherein the step of determining the patient's independent mobility skills comprises assigning a mobility data value representing the percentage of a complete patient transfer that the patient can accomplish independently.

27. A computer implemented method according to claim 26, wherein the step of determining the patient's independent mobility skills comprises comparing said mobility data value with a mobility threshold value to determine if no patient handling device is necessary for that patient.

28. A computer implemented method according to claim 26, wherein the step of specifying the patient handling device comprises assigning a gait-transfer belt to the patient when said mobility data value is greater than or equal to 50 percent.

29. A computer implemented method according to claim 27, wherein, if said mobility data value is less than 50 percent, the step of determining the patient's independent mobility skills comprises assigning a leg strength data value to the patient, the leg strength data value representing the patient's ability to bear weight on at least one of the patient's legs.

30. A computer implemented method according to claim 29, wherein, if said leg strength data value is below a leg strength threshold, said step of specifying the kind of patient handling device further comprises assigning the patient a slide board suitability value representing whether a slide board is appropriate to move the patient.

31. A computer implemented method according to claim 30, wherein, if said slide board suitability value represents an affirmative suitability, then the step of specifying the kind of patient handling device further comprises assigning the appropriate slide board for moving the patient.

32. A computer implemented method according to claim 30, wherein, if said slide board suitability value represents a negative suitability, then the step of specifying the kind of patient handling device further comprises calculating the appropriate total lift equipment.

33. A computer implemented method according to claim 29, wherein, if said leg strength data value is more than the leg strength threshold, then the step of specifying the kind of patient handling device further comprises assigning the patient an upper body strength data value and a cognitive ability data value for comparison to respective upper body and cognitive threshold values.

34. A computer implemented method according to claim 33, wherein, if either said upper body strength data value or said cognitive ability data value is below its respective threshold, then said step of specifying the kind of patient handling device comprises calculating the appropriate total lift.

35. A computer implemented method according to claim 33, wherein, if said upper body strength data value and said cognitive ability data value are both above their respective thresholds, said step of specifying the kind of patient handling device comprises matching the appropriate patient handling device to the patient's weight.

36. A computer implemented method according to claim 35, wherein said step of specifying the kind of patient handling device comprises specifying a sit to stand lift if the patient's weight is less than the weight limit per the lift vendor's specifications.

37. A computer implemented method according to claim 35, wherein said step of specifying the kind of patient handling device comprises specifying a total lift if the patient's weight is greater than the weight limit per the lift vendor's specifications for a sit to stand lift.

38. A computer implemented method according to claim 35, wherein said step of specifying the kind of patient handling device comprises determining the number of caregivers required to reposition the patient in bed.

39. A computer implemented method according to claim 35, wherein said step of specifying the equipment comprises specifying the appropriate patient handling device for repositioning the patient depending on the number of caregivers required.

40. A computer implemented method according to claim 23, wherein said step of specifying the equipment further comprises generating a sticker for display near the patient's bed, the sticker showing the equipment that should be used to move or reposition the patient.

41. A computerized system of specifying and tracking the safety protocol for physically moving patients in a healthcare facility, comprising:
a computer readable storage medium having an equipment specification module, a training module, a data tracking module, and an output module stored thereon, said specification, training, tracking, and output modules executable by a processor;
a data entry device for inputting data onto said storage medium for use by said modules;
computer-controlling patient commands within said equipment specification module for evaluating input patient data and assessing the patient safety protocol required to move the patient;
computer-controlling data tracking commands within said data tracking module for recording events associated with moving patients in the healthcare facility;
computer-controlling training commands within said training module for training system users in a method of moving patients in the healthcare facility; and
computer-controlling output commands within said output module that generate a system output from said modules.

42. A computerized system according to claim 41, wherein said system output is selected from the group consisting of a safety protocol for moving a patient, a caregiver data summary, a patient data summary, an injury summary, and any combination thereof.

43. A computerized system according to claim 41, wherein said data entry device comprises a weight prompt for entering the patient's weight.

44. A computerized system according to claim 41, wherein said data entry device comprises an equipment selection prompt for entering the kind of patient handling device to be used in moving the patient.

45. A computerized system according to claim 41, wherein said patient profile entry device comprises a reposition prompt for entering the number of people needed to reposition the patient in bed.

46. A computerized system according to claim 45, wherein said patient profile entry device comprises a prompt for entering the kind of sling for moving the patient.

47. A computerized system according to claim 46, wherein said equipment specification module comprises a computer readable storage medium having equipment specification commands stored thereon, said commands executable by a processor to direct said output module to show the image of the equipment that should be used in physically moving the patient.

48. A computerized system according to claim 47, wherein said output module shows equipment selected from the group consisting of a gait belt, a slide board, a total lift, and a sit to stand lift.

49. A computerized system according to claim 41, wherein said data tracking module comprises a computer record for each system user.

50. A computerized system according to claim 41, wherein said data tracking module comprises a computer record for each patient requiring a patient assessment.

51. A computerized system according to claim 41, wherein said data tracking module comprises an equipment tracking database for tracking each kind of equipment available for moving patients in the system user's healthcare facility.

52. A computerized system according to claim 51, wherein said equipment tracking database comprises a computer record for each piece of equipment, said record having details selected from the group consisting of image data, warranty data, parts data, service data, maintenance history data, and combinations thereof.

53. A computerized system according to claim 41, wherein said data tracking module records event data from said data entry device, said event data selected from the group consisting of patient biographical data, prior patient assessment dates, scheduled patient assessment dates, patient assessment results, patient weight, patient care instructions, patient location, and changes in patient location.

54. A computerized system according to claim 41, wherein said training module comprises video content directed to assessing a patient's safety protocol.

55. A computerized system according to claim 54, wherein said training module comprises a competency examination for system users.

56. A computerized system according to claim 55, wherein said data tracking module communicates with said training module and records the results of each user's competency examination.

57. A computerized system according to claim 41, wherein the system is configured in an internet-accessible server and client relationship, and wherein said data tracking module comprises a database.

58. A computerized system according to claim 57, wherein the server hosts a public website for gaining access to the system.

59. A computerized system according to claim 58, wherein said website comprises a client sub-domain for a healthcare facility using the system.

60. A computerized system according to claim 58, wherein said public website communicates with a second server dedicated to a client.

61. A computerized system of establishing a safety protocol for moving patients in a healthcare facility, comprising:
a computer readable storage medium comprising:
equipment specification commands stored on said storage medium, said equipment specification commands executable by a processor to assess the kind of equipment that should be used to move a patient; and
an injury tracking module stored on said storage medium, said module accessible by the system user to calculate trends in patient-moving safety;
the computerized system further comprising:
a data entry device for entering data regarding patients and injuries into said storage medium for use by said equipment specification commands and said injury tracking module; and
an output module for showing the equipment that should be used in physically moving the patient and for showing the calculated safety trends.

62. A computerized system according to claim 61, wherein said injury tracking module comprises a computer record of each patient-moving injury occurring in the user's healthcare facility.

63. A computerized system according to claim 61, wherein said data entry device comprises a client dashboard for the user to input injury claim data into said storage medium.

64. A computerized system according to claim 61, wherein said injury-tracking module further comprises a loss run application for confirming that an input injury claim is related to a patient move or transfer.

65. A computerized system according to claim 64, wherein said loss run application comprises a means for editing the claim detail entered through the client dashboard.
